(19) United States
(12) Patent Application Publication
(10) Pub. No.: US 2015/0061291 A1
(43) Pub. Date: Mar. 5, 2015

(54) VIBRATION DAMPING FOR A RANGE-EXTENDER

(71) Applicant: AVL List GmbH, Graz (AT)

(72) Inventors: Vincent BENDA, Buxheim (DE); Peter EBNER, Graz (AT); Richard SCHNEIDER, Graz (AT); Bernhard SIFFERLINGER, Graz (AT)

(21) Appl. No.: 14/536,383

(22) Filed: Nov. 7, 2014

Related U.S. Application Data
(63) Continuation of application No. PCT/EP2013/001357, filed on May 7, 2013.

(30) Foreign Application Priority Data
May 10, 2012 (AT) A50167/2012

(51) Int. Cl. B60L 11/12

(52) U.S. Cl. CPC B60L 11/123
USPC 290/45

(57) ABSTRACT

A range extender for a motor vehicle is disclosed. In one aspect, the range extender includes a first electromechanical energy converter including a rotor and an internal combustion engine configured to be coupled to the first electromechanical energy converter for transmitting power. The range extender further includes a first vibration damper integrated into the rotor of the first electromechanical energy converter.

### CROSS-REFERENCE TO RELATED APPLICATIONS

This application is a continuation application, and claims the benefit under 35 U.S.C. §§ 120 and 365 of PCT Application No. PCT/EP2013/001357, filed on May 7, 2013, which is hereby incorporated by reference. PCT/EP2013/001357 also claimed priority from Austrian Patent Application No. A 50167/2012 filed on May 10, 2012, which is hereby incorporated by reference.

### BACKGROUND

1. Field

The described technology generally relates to a range extender for a motor vehicle.

2. Description of the Related Technology

Range extenders denote additional power train elements in an electric motor vehicle, usually including a combustion engine which drives a generator to supply electrical energy to an energy storage device and/or an electric motor in order to extend the range of electric motor vehicles.

Accumulators or batteries which are charged in localized power supply systems are usually used as the energy storage devices for supplying energy to electric motor vehicles. Should no power supply system be available and the energy remaining in the energy storage device is almost drained, the range extender can recharge the energy storage device in transit or at least ensure that the electric motor vehicle can continue driving.

In electric motor vehicles equipped with a range extender, the internal combustion engine of the range extender normally starts and stops during travel without any direct action on the part of the driver, for example, as a function of the energy storage device's state of charge. Electrical energy is usually generated by means of an electromechanical energy converter; i.e., an electric motor which is normally a permanently energized synchronous motor.

The electromechanical energy converter usually has at least two operating modes which are controlled by the appropriate control electronics: a generator mode is the normal operation of the range extender. Conversely, it can also be operated in a motor mode. This mode is normally used to start the internal combustion engine.

However, the internal combustion engine of the range extender should not detract from the driving experience of the electric car, which is substantially attributable to the particular performance characteristics of the electromechanical energy converter serving as the traction drive and the absence of internal combustion engine noise in the drive train.

Disruptive factors originating from the internal combustion engine and/or the electromechanical energy converter of the range extender are therefore to be prevented or suppressed wherever possible.

Thus, noises upon starting and during operation of the range extender in addition to vibrations are normally to be prevented to the greatest extent possible.

WO 97/08435 relates to a system for actively reducing rotational irregularities of a shaft, for example, the drive shaft of a combustion engine or a shaft which is or can be coupled to the same. This system includes an electric motor which is or can be coupled to the shaft, wherein a control device controls the electric motor so that it counteracts the positive and negative rotational irregularities of the shaft.

### SUMMARY OF CERTAIN INVENTIVE ASPECTS

One inventive aspect is a range extender for an electric motor vehicle, comprising an electromechanical energy converter and an internal combustion engine configured to be coupled to the electromechanical energy converter for transmitting power.

Another aspect is an improved range extender which lessens the above-cited problems in a motor vehicle equipped with said range extender.

In the above range extender, a vibration damper is integrated into the rotor of the first electromechanical energy converter.

The vibration damping integrated into the rotor reduces or even completely suppresses vibrations and thus NVH (Noise, Vibration, Harshness) in all driving situations. This results in a substantially improved driving experience. For example, due to being integrated into the rotor of the electro-mechanical energy converter, damping can be realized in space-saving manner. Integration into the rotor means that the rotor of the first electromechanical energy converter is the secondary mass of a dual-mass flywheel serving as the vibration damper. In some embodiments, the primary mass of the dual-mass flywheel is thereby positioned directly on the shaft of the rotary piston engine. Doing so thus reduces the number of additional components for a vibration damper. Electronic control of the damping is also unnecessary in this case. In some embodiments, the vibration damping forms a simple, sturdy and economical apparatus.

In some embodiments, an electromechanical energy converter serves in the converting of electrical energy into mechanical energy and vice versa and includes, for example, electric motors and electric generators. Depending on which direction power is being transmitted, electro-mechanical energy converters vary between a motor mode, in which power is transmitted from the electrical side to the mechanical side, and a generator mode with a reverse flow of power.

In some embodiments, the internal combustion engine includes a thermal engine which converts the chemical energy of a fuel into mechanical energy in a combustion process. In an internal combustion engine operation, a drive element, for example, a piston is generally forced out of the combustion zone by the expansion of an air-fuel mixture upon combustion in a chamber, whereby this sets a drive shaft in motion, for example, in rotation.

In some embodiments, the motor vehicle includes a mobile means of transportation serving to transport goods, tools or persons and is machine-driven.

In some embodiments, the electric motor vehicle includes a motor vehicle driven by electrical energy from an energy storage device, for example, an electrochemical energy store, an accumulator and/or battery. When the energy storage device has been drained, it has to be recharged either via a power supply network or a portable supply device, for example, a range extender or solar cells.

In some embodiments, the vibration damper includes a damper configured to damp the torsional vibrations of the internal combustion engine's shaft by means of structural elements, for example, vibration damping to eliminate NVH. In four-stroke piston engines, but also in rotary piston engines, the periodic cycle of the four strokes (intake, compression, ignition, exhaust) in combination with the firing order of the individual cylinders or discs leads to rotational irregularities of the shaft and, for example, the connected flywheel. The inertia and rigidity of such a drive train produces a structure having characteristic natural frequencies capable of producing torsional vibrations which, due to the rotational irregularities introduced into a reciprocating engine or a rotary piston engine, unavoidably lead to torsional vibrations of the shaft. In some embodiments, the vibration damper includes a dual-mass flywheel, a torsion damper or any other known torsional vibration damper.

In some embodiments, the coupling to effect power transmission includes a mechanical, fluid- mechanical, hydromechanical or magnetic transmitting of power, for example, via a common shaft; i.e., the electromechanical energy converter and the internal combustion engine are coaxial.

NVH, which stands for Noise, Vibration, Harshness (in German: Gerausch, Vibration, Rauheit) is an important criterion when assessing the driving experience of a driver. Harshness thereby refers to both the audible as well as tactile vibration transitional range between 20 and 100 Hz. Generally speaking, NVH is caused by a source of vibration locally introducing force into a vibration-transmitting media such as, for example, the mechanical motor vehicle structure.

In some embodiments, the internal combustion engine is arranged between the first electromechanical energy converter and a second electromechanical energy converter, wherein the second electromechanical energy converter is also coupled to the internal combustion engine for transmitting power and/or vibration damping is integrated into the rotor of the second electromechanical energy converter.

The second electromechanical energy converter enables a more efficient converting of the internal combustion engine's mechanical energy into electrical energy. Furthermore, transverse forces on the bearings of the internal combustion engine can be lessened as bowing of the shaft due to the rotational irregularities of an internal combustion engine during operation can be reduced by the two electromagnetic energy converter guidances at both ends of the shaft.

In some embodiments, the internal combustion engine is a rotary piston engine.

In some embodiments, the rotary piston engine includes a device in which a substantially triangular piston rotates about a main axis in its housing during the operation of the internal combustion engine, wherein the piston rotates about its own axis which additionally, however, is moved about its own circular path. In other words, the piston realizes an orbital-like movement around the main axis. In some embodiments, advantageous in the use of a rotary piston engine as an internal combustion engine is the greater degree of smoothness to such an engine compared to a reciprocating engine. In some embodiments, this type of rotary piston engine includes a Wankel engine. The described technology can also be used in rotary piston engines having two, three or more adjacently arranged pistons. The described technology can also further be used in any other type of internal combustion engine, for example, a reciprocating engine.

In some embodiments, the rotary piston engine has greater smoothness to its operation such that it poses no disturbance to a motor vehicle's passengers. Moreover, the rotary piston engine generates substantially less noise than a conventional Otto or diesel engine. Lastly, substantially higher rotational speeds can be achieved than with a reciprocating engine.

In some embodiments, the rotor of the first and/or second electromechanical energy converter additionally comprises a mass damper.

In some embodiments, the mass damper includes a damper configured to absorb vibrational energy by the compressing or stretching of a material. The energy consumption, or the thermal energy generated respectively, accompanying same is taken from the vibration and has a damping effect. The mass damper can also be integrated into the rotor of the first and/or second electromechanical energy converter. The mass damper enables excess energy unable to be dissipated by the vibration damping to be converted into thermal energy. This thereby achieves a further reduction in vibrations.

### BRIEF DESCRIPTION OF THE DRAWINGS

FIG. 1 is a schematic depiction of a range extender according to a first embodiment.

FIG. 2 is a schematic depiction of a range extender according to a second embodiment.

### DETAILED DESCRIPTION OF CERTAIN INVENTIVE EMBODIMENTS

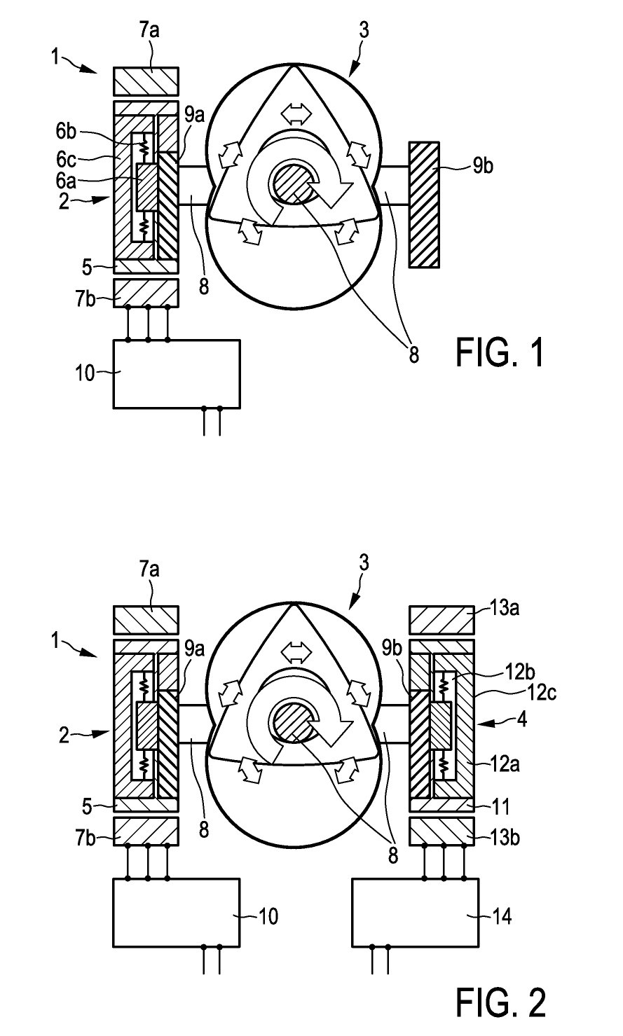

Reference will be made to FIG. 1 in the following in describing a first embodiment in greater detail. Embodiments will thereby be described using the example of a range extender 1 with a rotary piston engine having a substantially triangular rotary piston as an internal combustion engine 3. The rotary piston engine 3 is depicted in cross section, wherein the disc of the rotary piston engine 3 is rotated in the image plane so that the trochoidal form of the disc and the triangular form of the rotary piston or rotor respectively are visible. The shaft 8 is thereby depicted by a circle. The rotational direction of the rotary piston engine is indicated by a clockwise arrow around the shaft 8, the rotational direction could, however, also be counter-clockwise. The torsional vibration of the shaft 8 of the rotary piston engine 3 is further indicated by the double arrows.

However, the embodiment depicted is only an example. The unit could also be operated with any other type of internal combustion engine, for example, a reciprocating engine, such as an Otto or diesel engine.

In some embodiments, the range extender 1 includes a rotary piston engine 3 and an electromechanical energy converter 2. In some embodiments, the shaft 8 couples the rotary piston engine 3 to the electromechanical energy converter 2 for transmitting power. The rotary piston engine 3 and the first electromechanical energy converter 2 can be coaxial; i.e., the rotor 5 of the electromechanical energy converter 2 is mounted on the rotary piston engine 3 shaft.

The electromechanical energy converter 3 includes a rotor 5 and a stator 7a, 7b in which the rotor 5 turns due to an alternating electromagnetic field when the engine is operating. In some embodiments, the electromechanical energy converter 2 is an electric machine, for example, a pole machine, an internal or external pole machine, an asynchronous machine, a self-excited asynchronous machine or a reluctance machine.

The electromechanical energy converter 2 can be designed purely as a generator and/or as a generator engine. In a generator mode, it generates electrical energy from the torque provided to it via the shaft 8 of the rotary piston engine 3. The electrical energy is thereby generated by electromagnetic induction produced by the rotor 5 in the stator 7a, 7b of the first electro-mechanical energy converter 2. This electrical energy is fed via power electronics 10 into a circuit, for example, a direct current link of an electric motor vehicle. Alternatively or additionally, the electrical energy can however also be fed to the public power supply system.

Torsional vibrations which are induced by time-variable torques and overlap the rotation of the shaft 8 occur during the combustion process of the rotary piston engine 3. These torsional vibrations arise mainly due to the main harmonics of the gas and mass forces in the rotary piston engine 3. In some embodiments, a vibration damper 6a, 6b, 6c, for example, a flywheel or a dual-mass flywheel is used to exhaust the torsional vibration and is integrated into the rotor 5 of the first electromechanical energy converter 2. This means that although additional components are required for the vibration damper 6, they can be accommodated in space-saving manner by being integrated into the rotor 5. Thus, as FIG. 1 shows, the rotor 5 can be the secondary flywheel mass of a dual-mass flywheel. The primary flywheel mass can be mounted directly to the common shaft 8 of the rotary piston engine 3 and the first electromechanical energy converter 2. The primary flywheel mass can be integrated into the shaft. In some embodiments, the shaft 8 is the primary flywheel mass. The primary flywheel mass and the secondary flywheel mass can be coupled by steel or rubber springs 6b or any other type of flexible coupling means.

Furthermore, a balance mass 9a can also be integrated into the rotor 5 which counter-balances the unbalanced mass of the eccentric or the rotary piston respectively of the rotary piston engine 3. Furthermore, a mass damper for absorbing vibrations, which is not shown in the figures, can also be integrated into the rotor 5. This can be realized by additional elastic elements arranged between the primary flywheel mass 6a and the secondary flywheel mass 6c, with their compressing or elongating converting the vibrational energy into another form of energy, for example, thermal energy.

The balance mass can also be distributed on both ends of the shaft 8, whereby there are then two component balance masses 9a and 9b.

Reference will now be made to FIG. 2 in describing a range extender 1 according to a second embodiment.

The second embodiment can be combined with the first embodiment of FIG. 1 described above.

The second embodiment differs from the first embodiment in that a further, second electro-mechanical energy converter 4 is also provided on the opposite side from the first electro-mechanical energy converter 2 relative to the rotary piston engine 3 which can likewise be coupled to the shaft 8 of the rotary piston engine 3 for the transmitting of power, for example, coaxially with the rotary piston engine 3 and/or the first electromechanical energy converter 2. The second electromechanical energy converter 4 also includes a vibration damper 12a, 12b, 12c integrated into the rotor 11. In some embodiments, the balance mass 9b is integrated into the rotor 11 and the rotor can include a further mass damper which dissipates additional vibrational energy. The rotor 11 of the second electromechanical energy converter 4 also turns in a stator 13a, 13b in which electrical energy is generated during operation of the generator. This electrical energy as well is fed via power electronics 14 into a circuit, for example, a direct current link of an electric motor vehicle 14.

Range extenders in accordance with embodiments can also be used in buildings as a block-unit power station or as generator units for other mobile applications.

While the above description has pointed out features of various embodiments, the skilled person will understand that various omissions, substitutions, and changes in the form and details of the device or process illustrated may be made without departing from the scope of the appended claims.

What is claimed is:

1. A range extender for a motor vehicle, comprising:
a first electromechanical energy converter including a rotor;
an internal combustion engine configured to be coupled to the first electromechanical energy converter for transmitting power; and
a first vibration damper integrated into the rotor of the first electromechanical energy converter.

2. The range extender according to claim 1, wherein the internal combustion engine is arranged between the first electromechanical energy converter and a second electromechanical energy converter including a rotor, and wherein the second electromechanical energy converter is coupled to the internal combustion engine for transmitting power and/or a second vibration damper is integrated into the rotor of the second electromechanical energy converter.

3. The range extender according to claim 2, wherein each of the first and second vibration dampers comprises a dual-mass flywheel.

4. The range extender according to claim 2, further comprising a mass damper integrated into the rotor of at least one of the first and second electromechanical energy converters.

5. The range extender according to claim 2, further comprising a common shaft configured to couple the internal combustion engine to at least one of the first and second electromechanical energy converters.

6. The range extender according to claim 2, further comprising a balance mass integrated into the rotor of at least one of the first and second electromechanical energy converters.

7. The range extender according to claim 1, wherein the internal combustion engine comprises a rotary piston engine.

8. The range extender according to claim 1, wherein the motor vehicle further comprises an electric motor for propulsion of the vehicle.

9. A motor vehicle, comprising:
a range extender, wherein the range extender includes:
a first electromechanical energy converter including a rotor;
an internal combustion engine configured to be coupled to the first electromechanical energy converter for transmitting power; and
a vibration damper integrated into the rotor of the first electromechanical energy converter.

10. The motor vehicle according to claim 1, wherein the motor vehicle further comprises an electric motor for propulsion of the vehicle.
